(19) United States
(12) Patent Application Publication
(10) Pub. No.: US 2010/0003176 A1
(43) Pub. Date: Jan. 7, 2010

(54) PROCESS FOR PRETREATING ORGANIC EXTRACTANTS AND ITS PRODUCT AND APPLICATION

(76) Inventors: Xiaowei Huang, Beijing (CN); Hongwei Li, Beijing (CN); Zhiqi Long, Beijing (CN); Xinlin Peng, Beijing (CN); Dali Cui, Beijing (CN); Guilin Yang, Beijing (CN); Xinghua Luo, Beijing (CN); Na Zhao, Beijing (CN); Yongqi Zhang, Beijing (CN)

Correspondence Address: BIRCH STEWART KOLASCH & BIRCH, PO BOX 747, FALLS CHURCH, VA, 22040-0747, US

(21) Appl. No.: 12/526,436

(22) PCT Filed: Feb. 2, 2008
(86) PCT No.: PCT/CN2008/000280

§ 371 Date: Aug. 7, 2009

(30) Foreign Application Priority Data
Feb. 8, 2007 (CN) 200710003543.9
Jun. 4, 2007 (CN) 200710100027.8

(51) Int. Cl. C01F 17/00

(52) U.S. Cl. 423/21.1

(57) ABSTRACT

A process for pretreating organic extractants and its product and application in SX separation of rare earth. The pretreating method is that extractant and rare earth solution are mixed with powder or slurry of alkaline earth metal compound containing magnesium and/or calcium to realize pre-extraction, or the organic extractant are mixed with rare earth carbonate slurry to realize pre-extraction. When rare earth ion in aqueous phase is extracted into organic phase, the exchanged hydrogen ions enter into aqueous phase and dissolve the alkaline earth metal compound or the rare earth carbonate which helps to keep the acidity equilibrium of the system. The obtained organic extractant loaded with rare earth is used for unsaponificated SX separation of rare earth.

With this method, there is no need to saponificate organic extractant with liquid ammonia or alkali, and there is no ammonia-nitrogen wastewater produced. So separation cost decrease at a large scale and a lot of the cost to treat the three wastes is cut. This method is applicable to SX separation for all rare earth elements in chloride, sulphate and nitrate system and has advantages of low investment and high profit.

### FIELD OF THE INVENTION

The present invention relates generally to a process for pretreating organic extractants and its product and application in the SX (Solvent Extraction) separation of rare earth elements. More particularly according to the present invention, organic extractant and rare earth solution are mixed with powder or slurry of alkaline earth metal compound containing magnesium and/or calcium to realize pre-extraction, or organic extractant m with rare earth carbonate slurry to realize pre-extraction process. Rare earth ion in aqueous phase is extracted into organic phase, and exchanged hydrogen ion dissolves alkaline earth metal compounds or rare earth carbonates, then obtained organic extractant containing rare earth ions is used for unsaponificated SX separation of rare earth.

### BACKGROUND OF THE INVENTION

At present, solvent extraction (SX) is generally used for separation and purification of single rare earth in the industry The most widely used processes include: SX separation rare earth in the chloride system using saponificated HEHEHP, D2EHPA, Cyanex 272 etc. as extractant. For example:

[1] Rare Earth Chemistry Paper Collection, Changchun Applied Chemistry Research Institute, China, 1982, Science Press;

[2] Xu Guangxian, Rare Earth, 2^{nd} Edition (Book A), Beijing: Metallurgy Industry Press, 2002, P542˜547);

[3] A method for separation all rare earth elements from Yttrium-medium Europium-rich ion-type rare earth concentrate. (Chinese Patent: CN87101822);

[4] A process of separation mixed rare earth with solvent extraction using saponificated HEHEH-P. (Chinese Patent: CN85102210);

[5] A technology to continuous saponification of organic phase (Chinese Patent: CN95117989.6);

[6] Separation and purification of Yttrium oxide using saponificated naphthenic acid system (Xu Guangxian, Rare Earth, 2nd Edition (Book A), Beijing: Metallurgy Industry Press 2002, P582, 590).

The said extractants for above SX separation all belong to organic extractant. The extraction capacity (distribution ratio) of the extractant is inversely proportional to equilibrium acidity of aqueous phase. Therefore low acidity is required in SX separation.

Generally three hydrogen ions in organic extractant are exchanged into aqueous phase when a rare earth ion is extracted. Therefore the extractant should be saponificated in advance to remove hydrogen ions using such inorganic alkali as ammonia or sodium hydroxide, ammonium hydrocarbonate etc (reaction equation 1), then the ammonia or sodium ion is exchanged with rare earth ion (reaction equation 2).

HA+NH₄⁺═NH₄A+H⁺ equation 1

3NH₄A+RE³⁺══REA₃+3NH₄⁺ equation 2

HA denotes organic extractants, RE³⁺ denotes trivalent rare earth ions.

Thus it can be seen that a lot of ammonia would be consumed, which not only increases the cost, but also produces much ammonia-nitrogen wastewater which will pollute water resources seriously. It's difficult to recycle ammonia in the wastewater because of low concentration. And the recycle cost is too high to be accepted by factories. It's an urgent and difficult issue in the rare earth separation industry to eliminate the pollution of ammonia-nitrogen wastewater.

### OBJECTS OF THE INVENTION

The purpose of this invention is to provide a process for pretreating organic extractant, with which there is no ammonia nitrogen wastewater produced and the operation cost is low.

The inventor developed a method for pretreating acidic organic extractants based on the characteristic of HEHEHP, D2EHPA and cyanex 272 etc. Namely organic extractant is mixed directly with rare earth solution comprised of difficultly-extracted components, and powder or slurry of alkaline earth metal containing Magnesium and/or Calcium to realize pre-extraction. During this pretreating process, the hydrogen ions of extractant is exchanged by rare earth ions (see equation 3), rare earth ions being extracted into organic phase, then the exchanged hydrogen ion dissolves alkaline earth metal compounds, producing water and alkaline earth metal ions (see equation 4, 5). After pretreating process, the difficultly-extracted rare earth ions in the extractant, is exchanged with easily-extracted ones ( see equation 6). Difficultly-extracted rare earth ions will be separated from easily-extracted ones using multistage fraction extraction or countercurrent extraction.

REₐ³⁺+3(HA)₂══REₐ(HA₂)₃+3H⁺ equation 3

MO+2H⁺══M²⁺+H₂O equation 4

### Or

M(OH)₂+2H⁺══M²⁺+2H₂O equation 5

REₐ(HA₂)₃+RE_{b}³⁺══RE_{b}(HA₂)₃+REₐ³⁺ equation 6

M denotes alkaline earth metals, REₐ³⁺ denotes difficultly-extracted rare earth ions, RE_{b}³⁺ denotes easily-extracted rare earth ions.

Rare earth carbonates containing difficultly-extracted rare earth ions during fractional extraction separation, is mixed with a small quantity of water to make slurry, and then mixed with extractant afterward a series of reactions at a certain temperature happens. There is ion exchange between rare earth ions and H+ released from the extractants which let the rare earth ions be extracted into extractants (see equation 7), while the H+ compound with CO₃²⁻ producing CO2 and H2O which causes carbonates dissolution (see equation 8).

The difficultly-extracted rare earth ions contained in the pretreated extractants exchange with the easily-extracted rare earth ions when the pretreated extractants are used to extract and separate rare earth elements (see equation 9). Therefore, there is no H+ released from the extraction separation process, which results low and relatively constant equilibrium acidity. The difficultly-extracted rare earth ions are easily separated from the easily-extracted ones.

REₐ³⁺3HA══REₐA₃+3H⁺ equation 7

REₐ₂(CO₃)₃+6H⁺══2REₐ³⁺+3CO₂+3H₂O equation 8

REₐA₃+RE_{b}³⁺══RE_{b}A₃+REₐ³⁺ equation 9

REₐ³⁺ denotes difficulty-extracted rare earth ions , RE_{b}³⁺ denotes The easily-extracted rare earth ions

Hydrogen ions and alkaline earth metal ions don't take part in the process of extraction separation after the organic extractant is pretreated as above. There are significant advantages that the equilibrium acidity is constant in the extraction separation process, and alkaline earth metal content is low in the rare earth product afterward.

The specific technique methods of this invention are: The method of pretreatment of organic extractants includes the following process:

0.5 to 2 mol·L⁻¹ blank organic extractant and rare earth solution, are mixed with powder or slurry of alkaline earth metal compound containing Magnesium and/or Calcium, during which the rare earth metal ions in aqueous phase are extracted into organic phase, while the hydrogen ions exchanged from extractant dissolve alkaline earth metal compound of Magnesium and/or Calcium. Equilibrium pH value of the aqueous phase is 1.5˜5.5, and obtained organic extractants loaded with 0.05˜0.23 mol·L⁻¹ REO.

Single stage or 2˜15 stage cocurrent and/or countercurrent is used in the said pretreating, with mixing time 10˜80 minutes and the temperature in the extraction tank being controlled at 15˜90° C.

The said blank organic extractant is obtained by stripping from the SX separation The organic extractant comprises of single or mixture extractants from among acidic phosphorous extractant, alkyl phosphine oxide extractant and carboxylic acid extractant, wherein the extractant is diluted by organic solvent, and the concentration of extractant being 0.5˜1.7 mol·L⁻¹.

The said organic extractant is single or mixture system consist of 2-ethyl hexyl phosphonic acid mono 2-ethylhexyl ester ( HEHEHP, P507 ), di-(2-ethyl hexyl) phosphoric acid (D2EHPA, P204), di-(2-ethyl hexyl) phosphonic acid (P229), trialkyl phosphine oxide (TRPO), bis(2,4,4 trimethyl pentyl) phosphonic acid(HBTMPP, Cyanex272), bis(2,4,4 trimethyl pentyl) di-thiophosphinic acid (Cyanex301), bis(2,4,4 trimethyl pentyl) mono-thiophosphinic acid (Cyanex302), and the said diluent is single or mixture organic solvent consists of kerosene, solvent oil, alkane and organic alcohol, the concentration of extractant being 1˜1.5 mol·L⁻¹.

The said rare earth solution is the raffinate containing difficultly-extracted rare earth components during SX separation of rare earth, or the rare earth chloride, nitrate, sulphate or their mixture solution with the similar composition as the said raffinate with REO concentration 0.1˜1.8 mol/L.

The said alkaline metal compound of Magnesium and/or Calcium is single or mixture comprised of Magnesium oxide, Magnesium hydroxide, Calcium oxide, Calcium hydroxide, with medium particle diameter D₅₀ 0.1˜50 μm after being grinded and sieved and content of said alkaline metal compound is 1˜15 wt % (in terms of MgO/CaO) in the mixture aqueous phase.

The volume ratio of the said organic extractant to aqueous phase is O/A=0.3˜10, concentration of rare earth REO being 0.1˜0.20 mol·L⁻¹ in the loaded organic extractant after pretreating. The pH value of the preextraction raffinate is 1.5˜3, REO<0.05 mol/L, while the pH value and REO concentration is 3˜5 and below 0.003 mol/L respectively for the extraction raffinate obtained by the normal SX process. The residue rare earth in the said raffinate is recovered by SX using D2EHPA or HEHEHP, decreasing the RE concentration to less than 0.002 mol/L REO.

The said rare earth carbonate is the one comprised of difficultly-extracted rare earth components, with REO 30˜60 wt %, and solid content in the slurry is 2-30 wt % after slurry making.

The said loaded organic extractant which contains 0.05˜0.23 mol/L REO and obtained by the said pretreation process, is directly used to unsaponificated extraction and separation of rare earth in rare earth chloride solution, nitrate solution, sulphate solution or the mixture solution of the above. The SX separation is multistage fraction extraction or countercurrent extraction process, with the temperature 15˜90° C. in the reaction tank. The said rare earth elements are at least two from among Lanthanum, Cerium, Praseodymium, Neodymium, Samarium, Europium, Gadolinium, Terbium, Dysprosium, Holmium, Erbium, Thulium, Ytterbium, Lutetium and Yttrium.

### ADVANTAGES OF THIS INVENTION

In the present invention, organic extractant and rare earth solution are mixed with powder or slurry of alkaline earth metal compound containing Magnesium and/or Calcium to realize preextraction, or the extractant and solution are mixed with rare earth carbonate slurry to realize preextraction. In the process, rare earth ion is extracted into organic phase, then the newly exchanged hydrogen ions dissolve the alkaline earth metal compound or the rare earth carbonate, which helps to keep the acidity equilibrium of the system. The obtained organic extractant loaded with rare earth ions is used in unsaponificated SX of rare earth.

There is no need for organic extractant to be saponificated using liquid ammonia and liquid caustic soda before extraction and no ammonia-nitrogen wastewater produced in the rare earth SX separation. Therefore it significantly reduces the cost of rare earth separation and saved a lot cost of disposing three wastes. The method of this invention is applicable to SX separation of all the rare earth elements in the chloride system, sulphate system and nitrate system with low investment and high profit. For a plant of 3000 tons/a separation capacity for ion-type rare earth concentrate, with this method, it will cut down 2,800 tons liquid ammonia or 20,000 tons liquid caustic soda, which decreases the cost by 7˜12 million RMB and decrease 90,000 tons ammonia-nitrogen wastewater per year.

### EXAMPLES

The following non-limit examples shall serve to illustrate the various embodiments of the present invention.

### Example 1

Magnesium Oxide( MgO 92 wt %, medium particle diameter D₅₀ 3.5 μm), 0.35 mol/L Praseodymium chloride solution and 1.5 mol/L mixture extractants (HEHEHP (80% V/V) and D2EHPA (20%, V/V) ) are pretreated in the pretreation tank in which the mixing time is 20 minutes, with feeding rate of MgO is 0.80 kg/min, flow rate of PrC13 solution 38 L/min and organic phase 67 L/min. The organic phase loaded with Praseodymium (REO 0.18 mol/L) is obtained by 5 stage cocurrent, 3 stage countercurrent extraction. The pH value of preextraction raffinate is 2.0. 1.0 mol/L D2EHPA is directly used to extract the residual rare earth from the raffinate above, by which the residual rare earth in the pretreation raffinate is 0.0014 mol/L REO. And rare earth recovery rate is 99.8%. Then the obtained loaded organic phase is used to SX separation for Pr/Nd. 99.9% Praseodymium chloride and 99.9% Neodymium chloride are obtained through 93 stage fractional extraction.

### Example 2

Magnesium Oxide (MgO 88 wt %, medium particle diameter D50 1.2 μm) with feed rate 0.90 kg/min, 0.85 mol/L Praseodymium chloride solution with flow rate 16 L/min and 1.5 mol/L HEHEHP with flow rate 70 L/min are pretreated in the pretreation tank, in which the temperature is 48° C. and mixing time is 15 minutes. The organic phase loaded with Praseodymium (REO 0.187 mol/L) is obtained by 4 stage cocurrent and 3 stage countercurrent extraction. The pH value in the raffinate is 2.5. 1.0 mol/L D2EHPA is directly used to extract the residual rare earth from the raffinate above, and after 6 stage extraction, the residual rare earth in the raffinate is 0.002 mol/L. And rare earth recovery rate is 99.8%. Then the obtained loaded organic phase is used to SX separation for Pr/Nd. 99.5% Praseodymium chloride and 99.9% Neodymium chloride are obtained through 90 stage fractional extraction.

### Example 3

Magnesium oxide (MgO 88 wt %, medium particle diameter D₅₀ 1.5 μm) slurry (Solid content is 3 wt %) with feed rate 0.44 kg/min, 1.18 mol/L Praseodymium chloride solution with flow rate 5.2 L/min and 1.5 mol/L HEHEHP with flow rate 32 L/min are pretreated in the pretreation tank. The organic phase loaded with Praseodymium (REO 0.191 mol/L) is obtained by 4 stage concurrent, 2 stage counter current extraction and 2 stage settlement in which the mixing time is 15 minutes. The pH value and rare earth concentration of the preextraction raffinate is 3.0 and 0.0026 mol/L REO respectively. And rare earth recovery rate is 99.8%. Then the obtained loaded organic phase is used to SX separation for Pr/Nd. 99.9% Praseodymium chloride and 99.5% Neodymium chloride are obtained through 86 stage fractional extraction separation.

### Example 4

Calcium Oxide(CaO 91 wt %) with feed rate 0.45 kg/min, Lanthanum nitrate solution(0.526 mol/L REO) with flow rate 9.2 L/min and 1.0 mol/L D2EHPA with flow rate 32 L/min are pretreated in the pretreation tank, The organic phase loaded with Lanthanum (REO 0.151 mol/L) is obtained by 7 stage cocurrent and 3 stage countercurrent extraction in which the mixing time is 25 minutes. The pH value and rare earth concentration of the preextraction raffinate is 4.0 and 0.001 mol/LREO respectively. And rare earth recovery rate is 99.8%. Then the obtained loaded organic phase is directly used to SX separation for La/Ce. 99.99% Lanthanum nitrate and 99.9% cerium nitrate are obtained through 70 stage fractional extraction separation.

### Example 5

Magnesium hydroxide slurry (MgO 35 wt %) with feed rate 0.71 kg/min, 0.837 mol/L terbium chloride solution with flow rate 4.8 L/min and 1.5 mol/L HEHEHP with flow rate 22 L/min are pretreated in the pretreation tank in which the mixing time is 25 minutes. The organic phase loaded with terbium(REO 0.182 mol/L) is obtained by 3 stage cocurrent and 3 stage countercurrent extraction. The pH value and rare earth concentration of the preextraction raffinate is 3.5 and 0.002 mol/L REO respectively. And rare earth recovery rate is 99.6%. Then the obtained organic phase is used to SX separation for Tb/Dy. 99.9% dysprosium chloride and 99.99% terbium chloride are obtained through 72 stage fractional extraction separation.

### Example 6

Magnesium carbonate (MgO 47 wt %, medium particle diameter D₅₀ 1.1 μm) with feed rate 0.47 kg/min, 0.837 mol/L La—Ce chloride solution with flow rate 4.8 L/min and 1.5 mol/L HEHEHP with flow rate 22 L/min are pretreated in the pretreation tank. The La—Ce loaded organic phase with REO 0.182 mol/L is obtained by 4 stage cocurrent, 3 stage countercurrent extraction in which the contact time is 30 minutes. The pH value and rare earth concentration of the preextraction raffinate is 3.0 and 0.0029 mol/L REO respectively. And rare earth recovery rate is 99.7%. Then the obtained loaded organic phase is used to SX separation for Ce/Pr La—Ce chloride and Pr—Nd chloride are obtained through 75 stage fractional extraction separation.

### Example 7

Magnesium oxide slurry (MgO solid content is 7.5 wt %) with feed rate 0.30 kg/min, lanthanuim sulphate solution (0.29 mol/L) with flow rate 16 L/min and 1.3 mol/L D2EHPA with flow rate 32 L/min are pretreated in the pretreation tank in which the mixing time is 15 minutes. The organic phase loaded with Lanthanum (REO 0.143 mol/L) is obtained by 3 stage cocurrent and 3 stage countercurrent extraction. The pH value and rare earth concentration of the preextraction raffinate of is 3.0 and 0.0027 mol/L REO respectively. And rare earth recovery rate is 99.1%. Then the obtained loaded organic phase is used to SX separation for La/Ce. 99.99% Lanthanum chloride and 99.9% cerium chloride are obtained through 70 stage fractional extraction separation.

### Example 8

Rare earth sulphate solution obtained from Baotou rare earth concentrate is precipitated using ammonium hydrocarbonate, 412 kg mixed rare earth carbonate (REO 44%) of the said carbonate is used to make slurry with 3M³ water. The slurry is heated to 60° C. Then 6 M³ HEHEHP (1.5 mol/L, diluted in kerosene) is added to slurry and stirred for 15 minutes and settled for 15 minutes. Rare earth is extracted into organic phase. Organic phase loaded with rare earth from La to Gd is obtained, with rare earth concentration being 0.18 mol/L REO. This obtained organic phase is directly used in SX separation for Gd/Tb.

What is claimed is:

1. A process for pretreating organic extractants, wherein 0.5 to 2 mol·L⁻¹ blank organic extractant and rare earth solution are mixed with powder or slurry of alkaline earth metal compound containing magnesium and/or calcium, and rare earth ion in aqueous phase is extracted into organic phase, while the exchanged hydrogen ion dissolves alkaline earth metal compound containing magnesium and/or calcium, and equilibrium pH value of the aqueous phase is 1.5˜5.5, and obtained organic extractant loads REO 0.05˜0.23 mol·L⁻¹.

2. A process for pretreating organic extractants, wherein slurry of rare earth carbonate and small quantity of water is mixed with 0.5 to 2 mol·L⁻¹ blank organic extractant, and rare earth ion in aqueous phase is extracted into organic phase, then the exchanged hydrogen ion dissolves rare earth carbonate, and equilibrium pH value of the aqueous phase is 1.5˜5, and obtained organic extractant has concentration of REO 0.05˜0.23 mol·L⁻¹, and all of the extraction raffinate aqueous phase is recycled to make slurry.

3. The process of pretreating organic extractant of claim 1, wherein single stage or 2˜15 stage cocurrent and/or countercurrent extraction is used in said pretreating, and the contact time of two phases is 10 to 80 minutes, and temperature in the extraction tank is controlled at 15 to 95°.

4. The process of pretreating organic extractant of claim 1, wherein said blank organic extractant is obtained by stripping from the SX (Solvent Extraction, similarly hereinafter) separation process, and the organic extractant consists of single or mixture extractants from among acidic phosphorous extractant, alkyl phosphine oxide extractant and carboxylic acid extractant, and the organic extractant is diluted by organic solvent, and the concentration of the organic extractant is 0.5˜1.7 mol·L⁻¹.

5. The process of pretreating organic extractant of claim 4, wherein said organic extractant is single or mixture system consisting of 2-ethyl hexyl phosphonic acid mono 2-ethylhexyl ester ( HEHEHP, PC88A, P507), di-(2-ethyl hexyl) phosphoric acid (D2EHPA, P204 ), di-(2-ethyl hexyl) phosphonic acid (P229), trialkyl phosphine oxide (TRPO), bis(2,4,4 trimethyl pentyl) phosphonic acid (HBTMPP, Cyanex272), bis(2,4,4 trimethyl pentyl) dithiophosphinic acid (Cyanex301), bis(2,4,4 trimethyl pentyl) mono-thiophosphinic acid (Cyanex302), and the said diluent is single or mixture organic solvent consisting of kerosene, solvent oil, alkanes and organic alcohol. The concentration of the organic extractant is 1˜1.5 mol·L⁻¹.

6. The process of pretreating organic extractant of claim 1, wherein said rare earth solution is the raffinate containing difficultly-extracted rare earth components during the rare earth SX separation process, or the rare earth chloride, nitrate, sulphate or their mixture solution with the similar composition as the raffinate, and concentration in said rare earth solution is 0.1˜1.8 mol·L⁻¹. REO.

7. The process of pretreating organic extractant of claim 1, wherein said alkaline metal compound of magnesium and/or calcium is single or mixture comprised of magnesium oxide, magnesium hydroxide, magnesium carbonate, calcium oxide, calcium hydroxide, calcium carbonate, and medium particle diameter D₅₀ of the said compound is controlled in the range of 0.1˜50 μm, and content of said alkaline metal compound in the mixture aqueous phase is 1˜15 wt % (in terms of MgO and/or CaO).

8. The process of pretreating organic extractant of claim 7, wherein said alkaline compound of magnesium and/or calcium is single or mixture comprised of magnesium oxide, magnesium hydroxide, calcium oxide, calcium hydroxide, and medium particle diameter D50 of the said compound is controlled in the range of 0.5˜15 μm after being grinded and sieved, and content of said alkaline metal compound in the mixture aqueous phase is 2˜10 wt % (in terms of MgO and/or CaO).

9. The process of pretreating organic extractant of claim 1, wherein volume ratio of the said organic extractant to aqueous phase is O/A=0.3-10, and REO concentration of loaded organic extractant after pretreating is 0.1˜0.20 mol·L⁻¹.

10. The process of pretreating organic extractant of claim 1, wherein pH value of the pretreation extraction raffinate is between 1.5˜3, and REO in said raffinate is less than 0.05 mol·L⁻¹.

11. The process of pretreating organic extractant of claim 1, wherein pH value of the extraction raffinate is between 3˜5 and its REO less than 0.003 mol·⁻¹;.

12. The process of pretreating organic extractant of claim 1, wherein D2EHPA or HEHEHP is used to recover residual rare earth in said pretreation extraction raffinate, decreasing RE concentration to less than 0.002 molREO·L⁻¹.

13. The process of pretreating organic extractant as defined by claim 2, wherein said rare earth carbonate is comprised of difficultly-extracted rare earth components, and content of the rare earth carbonate is 30˜60 wt % REO, and solid content is 2-30 wt % in the slurry obtained by slurry-making.

14. The process of pretreating organic extractant of claim 1, wherein after pretreating said obtained organic extractant which is loaded with REO 0.05˜0.23 mol·L⁻¹.

15. The process of SX separation of rare earth using loaded organic extractant of claim 14, wherein said loaded organic extractant is directly used for unsaponificated SX separation process of rare earth in the rare earth chloride system, nitrate system, sulphate system or the mixture system of the above, and multistage fractional extraction or cocurrent/countercurrent extraction is used in SX separation, and the temperature in the extraction tank is controlled at 15˜90°.

16. The process of SX separation of rare earth using organic extractant of claim 15, wherein said rare earth elements are at least two from among Lanthanum, Cerium, Praseodymium, Neodymium, Samarium, Europium, Gadolinium, Terbium, Dysprosium, Holmium, Erbium, Thulium, Ytterbium, Lutetium and Yttrium.

17. The process of pretreating organic extractant of claim 2, wherein single stage or 2˜15 stage cocurrent and/or countercurrent extraction is used in said pretreating, and the contact time of two phases is 10 to 80 minutes, and temperature in the extraction tank is controlled at 15 to 95°.

18. The process of pretreating organic extractant of claim 2, wherein said blank organic extractant is obtained by stripping from the SX (Solvent Extraction, similarly hereinafter) separation process, and the organic extractant consists of single or mixture extractants from among acidic phosphorous extractant, alkyl phosphine oxide extractant and carboxylic acid extractant, and the organic extractant is diluted by organic solvent, and the concentration of the organic extractant is 0.5˜1.7 mol·L⁻¹.

19. The process of pretreating organic extractant of claim 2, wherein volume ratio of the said organic extractant to aqueous phase is O/A=0.3-10, and REO concentration of loaded organic extractant after pretreating is 0.1˜0.20 mol·L⁻¹.

20. The process of pretreating organic extractant of claim 10, wherein D2EHPA or HEHEHP is used to recover residual rare earth in said pretreation extraction raffinate, decreasing RE concentration to less than 0.002 molREO·L⁻¹.
